(19) United States
(12) Patent Application Publication
(10) Pub. No.: US 2021/0331708 A1
(43) Pub. Date: Oct. 28, 2021

(54) TRAVELING VEHICLE SYSTEM

(71) Applicant: Murata Machinery, Ltd., Kyoto-shi (JP)

(72) Inventor: Masayuki Takahara, Inuyama-shi (JP)

(21) Appl. No.: 17/272,429

(22) PCT Filed: Jul. 16, 2019
(86) PCT No.: PCT/JP2019/027967

§ 371 Date: Mar. 1, 2021

(30) Foreign Application Priority Data
Sep. 5, 2018 (JP) 2018-166328

(51) Int. Cl. B60W 60/00

(52) U.S. Cl. CPC B60W 60/0027; B60W 2510/18; B60W 2554/4045; B60W 2554/4049

(57) ABSTRACT

In a traveling vehicle system, a traveling vehicle transmits a passage permission request to a controller when reaching a request point upstream of a merging portion of a track, passes through the merging portion when receiving passage permission of the merging portion, and stops at a stopping point when the passage permission is not received. The controller includes a storage unit that stores requested traveling vehicles and priority information concerning the priority of each requested traveling vehicle, and a passage-permission determination unit that, while a plurality of requested traveling vehicles having routes entering the merging portion different from one another are stored in the storage unit, when any of the requested traveling vehicles reached a determination point, determines whether to transmit the passage permission to the relevant requested traveling vehicle that has reached the determination point based on the priority information.

### TECHNICAL FIELD

This disclosure relates to a traveling vehicle system.

### BACKGROUND

As a conventional traveling vehicle system, a system provided with a track having a merging portion in a part, a plurality of traveling vehicles traveling along the track, and a controller controlling the traveling vehicles has been known. As a technique of this type, in Japanese Patent No. 4135715, a traveling vehicle system that, when a controller receives a passage permission request (entry permission request) of a merging portion from a plurality of traveling vehicles, grants passage permission to the traveling vehicles in order of receiving has been disclosed, for example.

In the traveling vehicle system as described above, there may be a situation where a traveling vehicle having a lower priority (for example, a vacant traveling vehicle) passes through the merging portion before a traveling vehicle having a higher priority (for example, a traveling vehicle executing a transport command) and the traveling vehicle having the higher priority stands by short of the merging portion.

It could therefore be helpful to provide a traveling vehicle system in which a plurality of traveling vehicles can pass through a merging portion in order and according to priority.

### SUMMARY

I thus provide:

A traveling vehicle system includes: a track having a merging portion in a part; a plurality of traveling vehicles configured to travel along the track; and a controller configured to control the traveling vehicles, each of the traveling vehicles transmits a passage permission request to the controller when reaching a request point upstream of the merging portion in the track, passes through the merging portion when receiving passage permission of the merging portion, and stops at a stopping point downstream of the request point in the track and upstream of the merging portion when not receiving the passage permission, and the controller includes a storage unit configured to store therein requested traveling vehicles that are one or a plurality of traveling vehicles that have transmitted the passage permission requests and priority information concerning priority of each requested traveling vehicle, and a passage-permission determination unit configured to, when any of the requested traveling vehicles reach a determination point upstream of the stopping point in the track while the requested traveling vehicles having routes entering the merging portion different from one another are stored in the storage unit, determine whether to transmit the passage permission to the relevant requested traveling vehicle that has reached the determination point, based on the priority information stored in the storage unit.

In this traveling vehicle system, by using the time it takes until the requested traveling vehicle that has transmitted the passage permission request of the merging portion at the request point travels to the determination point, the priority information on another requested traveling vehicle that attempts to pass through the merging portion (traveling vehicle competing concerning the passage of the merging portion) can be stored. By using this priority information, it can be determined whether to transmit the passage permission to the relevant requested traveling vehicle that has reached the determination point. Thus, on a plurality of requested traveling vehicles, it is possible to pass through the merging portion in an appropriate order according to the priority of the requested traveling vehicles regardless of the order that the controller received the passage permission requests. That is, the traveling vehicles become possible to pass through the merging portion in order and according to priority.

The priority information may include information on whether the requested traveling vehicle is an executing traveling vehicle executing a transport command on an article or a vacant traveling vehicle, and the passage-permission determination unit, when a first requested traveling vehicle and a second requested traveling vehicle having routes entering the merging portion different from each other are present and when the first requested traveling vehicle is the vacant traveling vehicle and the second requested traveling vehicle is the executing traveling vehicle, may determine whether to transmit the passage permission to the first requested traveling vehicle that has reached the determination point, after transmitting the passage permission to the second requested traveling vehicle that reached the determination point. This makes it possible that the executing traveling vehicle passes through the merging portion before the vacant traveling vehicle.

The priority information may include: information on whether the requested traveling vehicle is an executing traveling vehicle executing a transport command on an article or a vacant traveling vehicle; and information concerning order of priority of the transport command, and the passage-permission determination unit, when a third requested traveling vehicle and a fourth requested traveling vehicle having routes entering the merging portion different from each other are present and when the third requested traveling vehicle is the executing traveling vehicle executing a first transport command and the fourth requested traveling vehicle is the executing traveling vehicle executing a second transport command having a higher order of priority than the first transport command, may determine whether to transmit the passage permission to the third requested traveling vehicle that has reached the determination point, after transmitting the passage permission to the fourth requested traveling vehicle that reached the determination point. This makes it possible that the executing traveling vehicle executing the transport command having a higher order of priority passes through the merging portion before the executing traveling vehicle executing the transport command having a lower order of priority.

The priority information may include information on whether the requested traveling vehicle is an executing traveling vehicle executing a transport command on an article or a vacant traveling vehicle, and the passage-permission determination unit, when a fifth requested traveling vehicle, a sixth requested traveling vehicle located behind the fifth requested traveling vehicle in the track and having a same route entering the merging portion as the fifth requested traveling vehicle, and a seventh requested traveling vehicle having a route entering the merging portion different from the fifth requested traveling vehicle and the sixth requested traveling vehicle are present and when the fifth requested traveling vehicle is the vacant traveling vehicle, the sixth requested traveling vehicle is the executing traveling vehicle, and the seventh requested traveling vehicle is the executing traveling vehicle, may determine whether to transmit the passage permission to the seventh requested traveling vehicle that has reached the determination point, after transmitting the passage permission to the fifth requested traveling vehicle that reached the determination point and transmitting the passage permission to the sixth requested traveling vehicle that reached the determination point. In this instance, the sixth requested traveling vehicle that is the executing traveling vehicle preferentially passes through the merging portion, and the fifth requested traveling vehicle that is the vacant traveling vehicle and has to pass through the merging portion inevitably in order for the sixth requested traveling vehicle to pass through the merging portion passes through the merging portion before without waiting for passage. Thus, the system as a whole can achieve efficient traveling of the traveling vehicles.

The priority information may include information on whether the requested traveling vehicle is an executing traveling vehicle executing a transport command on an article or a vacant traveling vehicle, and the passage-permission determination unit, when a first traveling vehicle group composed of the traveling vehicles having a same route entering the merging portion and a second traveling vehicle group composed of the requested traveling vehicles having a same route entering the merging portion and being different from the first traveling vehicle group are present, and when at least one of the requested traveling vehicles in the first traveling vehicle group is the executing traveling vehicle and all requested traveling vehicles in the second traveling vehicle group are the vacant traveling vehicles, may determine whether to transmit the passage permission to the requested traveling vehicle of the second traveling vehicle group, after transmitting the passage permission to all requested traveling vehicles in the first traveling vehicle group. This makes it possible that the executing traveling vehicle passes through the merging portion before the vacant traveling vehicle and that a plurality of traveling vehicles attempting to enter the merging portion on the same route pass through the merging portion successively.

The priority information may include: information on whether the requested traveling vehicle is an executing traveling vehicle executing a transport command on an article or a vacant traveling vehicle; and information concerning priority that is greater as an order of priority of the transport command is higher, and the passage-permission determination unit, when a third traveling vehicle group composed of the requested traveling vehicles having a same route entering the merging portion and a fourth traveling vehicle group composed of the requested traveling vehicles having a same route entering the merging portion and being different from the third traveling vehicle group are present, and when at least one of the requested traveling vehicles in the third traveling vehicle group is the executing traveling vehicle, at least one of the requested traveling vehicles in the fourth traveling vehicle group is the executing traveling vehicle, and a sum of priority of the transport command being executed by the executing traveling vehicle included in the third traveling vehicle group is greater than a sum of priority of the transport command being executed by the executing traveling vehicle included in the fourth traveling vehicle group, may determine whether to transmit the passage permission to the requested traveling vehicle of the fourth traveling vehicle group, after transmitting the passage permission to all requested traveling vehicles in the third traveling vehicle group. This makes it possible that the executing traveling vehicle that is executing the transport command having a higher order of priority is made easy to pass through the merging portion before the executing traveling vehicle that is executing the transport command having a lower order of priority and that a plurality of traveling vehicles attempting to enter the merging portion on the same route pass through the merging portion successively.

The passage-permission determination unit, when an eighth requested driving vehicle and a ninth requested traveling vehicle having routes entering the merging portion different from each other are present, may determine whether the eighth requested traveling vehicle is able to complete passage of the merging portion before the ninth requested traveling vehicle starts decelerating in order to stop at the stopping point, and when determined possible to pass through the merging portion as a result of the relevant determination, may determine whether to transmit the passage permission to the ninth requested traveling vehicle that has reached the determination point, after transmitting the passage permission to the eighth requested traveling vehicle that reached the determination point. This makes it possible, on the eighth requested traveling vehicle that can pass through the merging portion before the ninth requested traveling vehicle, to pass through the merging portion preferentially.

It is thus possible to provide a traveling vehicle system in which a plurality of traveling vehicles can pass through a merging portion in order and according to priority.

### BRIEF DESCRIPTION OF THE DRAWINGS

FIG. 1 is a schematic plan view illustrating a traveling vehicle system according to a first example.

FIG. 2 is a side view illustrating a traveling vehicle of the traveling vehicle system in FIG. 1.

FIG. 3 is a block diagram illustrating an area controller of the traveling vehicle system in FIG. 1.

FIG. 4 is a flowchart illustrating processing of the area controller in FIG. 3.

FIG. 5 is a flowchart illustrating processing of passage permission determination by a passage-permission determination unit in FIG. 3.

FIG. 6(a) is a schematic plan view explaining a processing example executed in the traveling vehicle system in FIG. 1.

FIG. 6(b) is a schematic plan view illustrating a continuation of FIG. 6(a).

FIG. 6(c) is a schematic plan view illustrating a continuation of FIG. 6(b).

FIG. 7(a) is a schematic plan view illustrating a configuration of FIG. 6(c).

FIG. 7(b) is a schematic plan view illustrating a continuation of FIG. 7(a).

FIG. 7(c) is a schematic plan view illustrating a continuation of FIG. 7(b).

FIG. 8 is a schematic plan view explaining a processing example executed in a traveling vehicle system according to a second example.

FIG. 9 is a schematic plan view explaining a processing example executed in a traveling vehicle system according to a third example.

FIG. 10 is a schematic plan view explaining a processing example executed in a traveling vehicle system according to a fourth example.

FIG. 11 is a schematic plan view explaining a processing example executed in a traveling vehicle system according to a fifth example.

FIG. 12 is a schematic plan view explaining a processing example executed in a traveling vehicle system according to a sixth example.

### REFERENCE SIGNS LIST

1 TRAVELING VEHICLE SYSTEM
4 TRACK
6 TRAVELING VEHICLE (REQUESTED TRAVELING VEHICLE)
6₁ FIRST REQUESTED TRAVELING VEHICLE
6₂ SECOND REQUESTED TRAVELING VEHICLE
6₃ THIRD REQUESTED TRAVELING VEHICLE
6₄ FOURTH REQUESTED TRAVELING VEHICLE
6₅ FIFTH REQUESTED TRAVELING VEHICLE
6₆ SIXTH REQUESTED TRAVELING VEHICLE
6₇ SEVENTH REQUESTED TRAVELING VEHICLE
6₈ EIGHTH REQUESTED TRAVELING VEHICLE
6⁹ NINTH REQUESTED TRAVELING VEHICLE
6T EXECUTING TRAVELING VEHICLE
6E VACANT TRAVELING VEHICLE
50 AREA CONTROLLER (CONTROLLER)
51 STORAGE UNIT
52 PASSAGE-PERMISSION DETERMINATION UNIT
G1 FIRST TRAVELING VEHICLE GROUP
G2 SECOND TRAVELING VEHICLE GROUP
G3 THIRD TRAVELING VEHICLE GROUP
G4 FOURTH TRAVELING VEHICLE GROUP
D DETERMINATION POINT
M MERGING PORTION
R REQUEST POINT
S STOPPING POINT

### DETAILED DESCRIPTION

With reference to the accompanying drawings, the following describes selected examples. In the description of the drawings, identical constituent elements are denoted by identical reference signs, and redundant explanations are omitted. The dimension ratios in the drawings do not always match those described.

### First Example

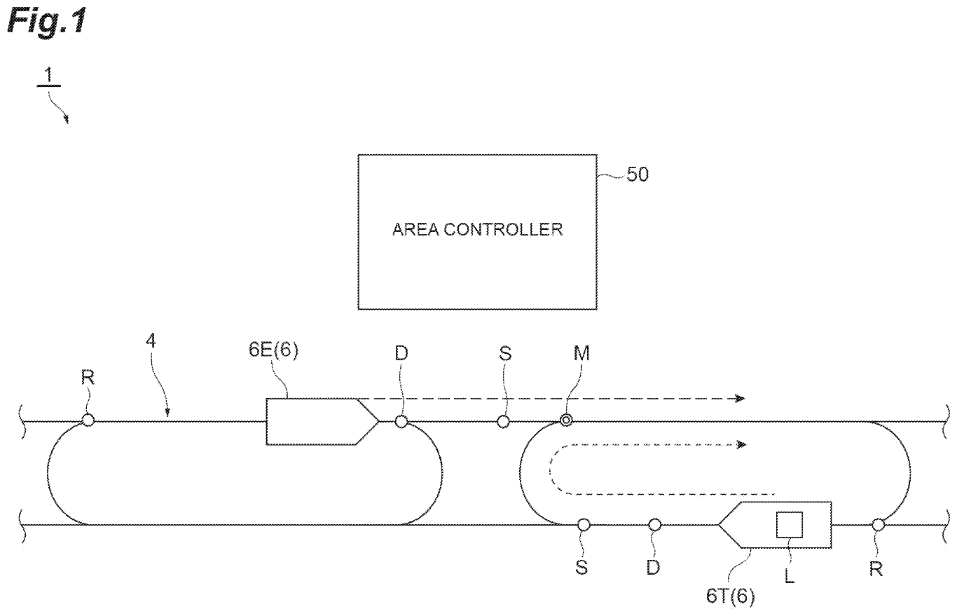

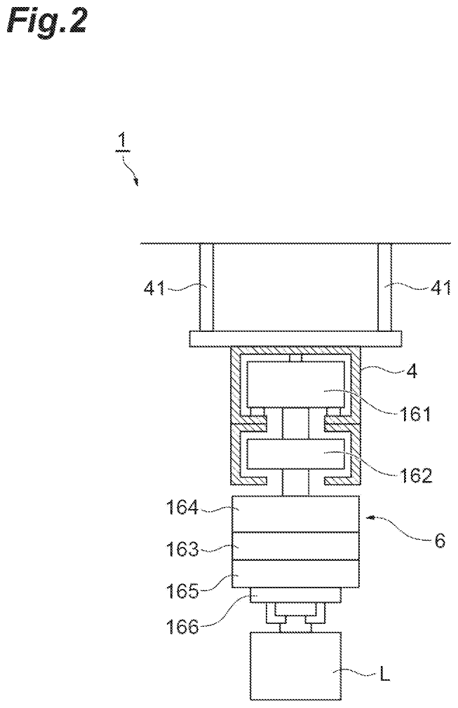

As illustrated in FIGS. 1 and 2, a traveling vehicle system 1 constitutes a transportation system that transports an article L. The article L, for example, is a container that accommodates therein a plurality of semiconductor wafers, but may be a glass substrate, a general component and the like. The traveling vehicle system 1 includes a track 4, traveling vehicles 6, and an area controller (controller) 50.

The track 4 is a predetermined traveling path for traveling the traveling vehicles 6. The track 4 is laid near the ceiling that is an overhead space of a worker, for example. The track 4 is suspended from the ceiling. The track 4 is supported by supporting columns 41. The track 4 has, in a part, a merging portion M at which a plurality of routes are merged. The routes include straight routes and curved routes. The layout of the track 4 (configuration of routes, and the number of merging portions M that the track 4 has) is not particularly limited and various layouts can be employed.

On the upstream of the merging portion M in the track 4, a request point R that is a position at which the traveling vehicle 6 transmits a passage permission request is provided. Specifically, in each of a plurality of routes entering (coupling to) the merging portion M upstream of the relevant merging portion M, the request point R is set upstream of the merging portion M. The request point R is a position that varies depending on the speed of the traveling vehicle 6. For example, the request point R is a position based on the time it takes until the traveling vehicle 6 reaches the merging portion M. For example, the distance between the merging portion M and the request point R is determined such that the time it takes until the traveling vehicle 6 reaches the merging portion M after passing through the request point R is equal for each of the routes. For example, as the speed of the traveling vehicle 6 is lower, the distance between the merging portion M and the request point R is smaller.

On the downstream of the request point R in the track 4 and the upstream of the merging portion M, provided is a stopping point S that is a position for stopping the traveling vehicle 6 that has not received the passage permission of the merging portion M. Specifically, in each of the routes entering the merging portion M upstream of the relevant merging portion M, the stopping point S is set at a position away from the request point R to the downstream side and away from the merging portion M to the upstream side. The stopping point S is set when the route to the merging portion M is a straight route at a peripheral position upstream of the merging portion M. The stopping point S is set when the route to the merging portion M includes a curved route at a peripheral position upstream of a position where the curve starts. The stopping point S is a predetermined position.

On the downstream of the request point R in the track 4 and the upstream of the stopping point S, provided is a determination point D that is a position for determining whether to grant the passage permission of the merging portion M to the traveling vehicle 6. Specifically, in each of the routes entering the merging portion M upstream of the relevant merging portion M, the determination point D is set at a position away from the request point R to the downstream side and away from the stopping point S to the upstream side. The determination point D is a position that varies depending on the speed of the traveling vehicle 6. For example, the determination point D is a position based on the time it takes until the traveling vehicle 6 reaches the merging portion M. For example, the distance between the merging portion M and the determination point D is determined such that the time it takes until the traveling vehicle 6 reaches the merging portion M after passing through the determination point D is equal for each of the routes. For example, as the speed of the traveling vehicle 6 is lower, the distance between the merging portion M and the determination point D is smaller. The request point R, the stopping point S, and the determination point D can be set based on a plurality of point marks (bar codes and the like) affixed to be lined up at regular intervals along the track 4. The request point R, the stopping point S, and the determination point D are set for each of a plurality of merging portions M. In the drawings, for the convenience of explanation, the merging portion M, the request point R, the stopping point S, and the determination point D are indicated by circles on the track 4.

The traveling vehicle 6 travels along the track 4. The traveling vehicle 6 conveys the article L. The traveling vehicle 6 is configured so that the article L can be transferred to a port not depicted. The traveling vehicle 6 is a ceiling traveling type unmanned traveling vehicle. The traveling vehicle 6 is also referred to as a carriage (transportation carriage), a ceiling traveling vehicle (ceiling traveling carriage), or a transport vehicle (transportation carriage), for example. The number of traveling vehicles 6 that the traveling vehicle system 1 includes is not particularly limited and is plural.

The traveling vehicle 6 includes a traveling unit 161 and a power-receiving communication unit 162. The traveling unit 161 causes the traveling vehicle 6 to travel along the track 4. The power-receiving communication unit 162 receives power from the track 4 side by non-contact power supply, for example. The traveling vehicle 6 performs communication with the area controller 50 by using a power feeder and the like of the track 4. Alternatively, the traveling vehicle 6 may perform communication with the area controller 50 via a communication line (feeder line) provided along the track 4, separately from the power feeder. The traveling vehicle 6 is provided with a θ drive 163 and a transverse feed unit 164 for transverse feeding a portion below the θ drive 163 with respect to the track 4. The θ drive 163 causes an elevating drive unit 165 to rotate in a horizontal plane to control the posture of the article L. The elevating drive unit 165 raises and lowers a lifting platform 166 holding the article L. The lifting platform 166 is provided with a chuck and is configured to freely grasp or release the article L. The transverse feed unit 164 and the θ drive 163 may be not provided.

The traveling vehicle 6 includes a position acquisition unit (not depicted) that acquires positional information concerning the position of the relevant traveling vehicle 6 on the track 4. The position acquisition unit is composed of a reading unit for reading point marks on the track 4, an encoder and the like. The positional information on the traveling vehicle 6 includes information on the point mark obtained by the reading unit and information concerning the traveling distance from passing through the relevant point mark.

The traveling vehicle 6 attempting to enter the merging portion M transmits a passage permission request to the area controller 50 when reaching the request point R in the track 4. The traveling vehicle 6 transmits a determination request to the area controller 50 when reaching the determination point D in the track 4. The area controller 50 determines, as described later, whether to grant passage permission to the traveling vehicle 6 when receiving the determination request from the traveling vehicle 6, and transmits the passage permission when the determination is affirmed and does not transmit the passage permission when denied. The traveling vehicle 6 passes through the merging portion M when the passage permission of the merging portion M is received from the area controller 50. The traveling vehicle 6 stops at the stopping point S on the traveling route when the passage permission of the merging portion M is not received from the area controller 50.

Whether the request point R and the determination point D have been reached can be determined based on the positional information acquired by the above-described position acquisition unit. The passage permission request of the merging portion M is a signal requesting the permission of passing through the merging portion M. The passage permission of the merging portion M is a signal to permit the passage of the merging portion M. The determination request of the merging portion M is a signal requesting the determination whether to transmit the passage permission of the merging portion M.

The area controller 50 is an electronic control unit composed of a central processing unit (CPU), a read only memory (ROM), a random access memory (RAM) and the like. The area controller 50 can be configured as software for which a program stored in the ROM is loaded on the RAM and executed by the CPU, for example. The area controller 50 may be configured as hardware by an electronic circuit or the like. The area controller 50 may be composed of a single device or may be composed of a plurality of devices. When composed of multiple devices, a single area controller 50 is logically constructed as the multiple devices are connected via a communication network such as the Internet or an intranet.

The area controller 50 performs communication with a plurality of traveling vehicles 6 in its own jurisdiction area and controls the traveling vehicles 6 in the own jurisdiction area. The area controller 50 performs communication with an upper controller (not depicted) in a wired or wireless manner. The area controller 50 receives from the upper controller a transport command that causes the traveling vehicle 6 to transport the article L.

The area controller 50 assigns the received transport command to a vacant traveling vehicle 6E. The vacant traveling vehicle 6E is a traveling vehicle 6 to which the transport command is not assigned and includes a traveling vehicle 6 that is in an empty state not transporting the article L. The vacant traveling vehicle 6E includes the traveling vehicle 6 that is traveling by a purposeful movement command (for example, a park traveling command for traveling to a standby section and an expulsion traveling command for leaving the standby section). The vacant traveling vehicle 6E includes the traveling vehicle 6 that is traveling by a movement command of no purpose (in idle traveling).

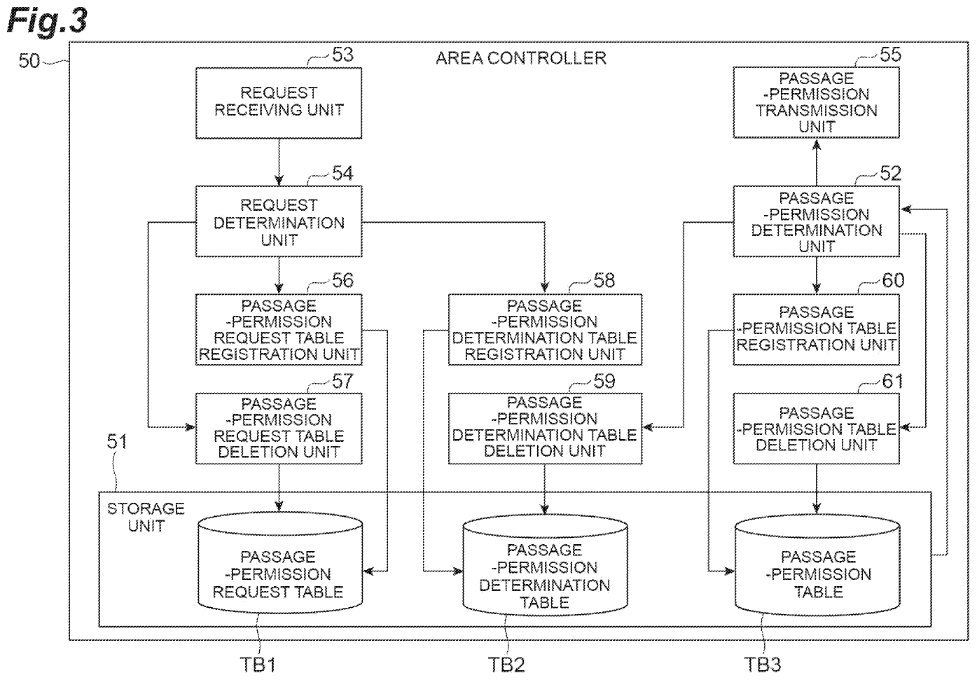

As illustrated in FIG. 3, the area controller 50 includes a storage unit 51, a passage-permission determination unit 52, a request receiving unit 53, a request determination unit 54, a passage-permission transmission unit 55, a passage-permission request table registration unit 56, a passage-permission request table deletion unit 57, a passage-permission determination table registration unit 58, a passage-permission determination table deletion unit 59, a passage-permission table registration unit 60, and a passage-permission table deletion unit 61.

The storage unit 51 stores therein one or a plurality of traveling vehicles 6 that have transmitted passage permission requests (hereinafter also referred to as “requested traveling vehicle 6”). Specifically, the storage unit 51 includes a passage-permission request table TB1, a passage-permission determination table TB2, and a passage permission table TB3, and stores the requested traveling vehicle 6 as a traveling vehicle number in them. In the storage unit 51, the traveling vehicle number of the requested traveling vehicle 6 that has transmitted a passage permission request is stored in the passage-permission request table TB1. The traveling vehicle number of the requested traveling vehicle 6 that has transmitted a determination request is deleted from the passage-permission request table TB1 and is stored in the passage-permission determination table TB2. The traveling vehicle number of the requested traveling vehicle 6 that has been determined to transmit the passage permission (to grant the passage permission) by the passage-permission determination unit 52 is deleted from the passage-permission determination table TB2 and is stored in the passage permission table TB3.

Furthermore, the storage unit 51 stores therein priority information concerning the priority of each requested traveling vehicle 6. The priority is an index representing the degree of priority. The priority information includes information whether the requested traveling vehicle 6 is an executing traveling vehicle 6T or a vacant traveling vehicle 6E. The executing traveling vehicle 6T is a traveling vehicle executing a transport command on the article L. That is, the executing traveling vehicle 6T is a traveling vehicle to which the transport command has been assigned. The priority of the executing traveling vehicle 6T is higher than the priority of the vacant traveling vehicle 6E.

The priority information includes information concerning the order of priority of transport command that the executing traveling vehicle 6T is executing. The information concerning the order of priority of transport command can be represented by the information for which the priority is greater as the order of priority is higher. The priority can be represented by a numerical value, for example. For example, a numerical value representing the priority is defined to each transport command, and as the numerical value is greater, the order of priority (urgency) of the transport command is higher. The priority information includes information concerning the elapsed time since the transport command has been assigned. The priority is higher as the elapsed time is longer.

The priority information includes information on whether the executing traveling vehicle 6T is in load-grabbing traveling or in unloading traveling. The executing traveling vehicle 6T in load-grabbing traveling is a traveling vehicle that is in traveling with a load-grabbing port as a destination in order to receive the article L at the load-grabbing port specified in the transport command, and does not hold the article L. The executing traveling vehicle 6T in unloading traveling is a traveling vehicle that is in traveling with an unloading port as a destination in order to deliver the article L to the unloading port specified in the transport command, and holds the article L. The priority of the executing traveling vehicle 6T in unloading traveling is higher than the priority of the executing traveling vehicle 6T in load-grabbing traveling. The priority information includes information on whether the vacant traveling vehicle 6E is in idle traveling or in traveling by a purposeful movement command. The priority of the vacant traveling vehicle 6E in traveling by a purposeful movement command is higher than the priority of the vacant traveling vehicle 6E in idle traveling. The priority information includes information on the route to which the requested traveling vehicle 6 enters the merging portion M (that is, the direction of entering the merging portion M). The priority information includes information concerning the distance of the requested traveling vehicle 6 to the merging portion M. The priority information includes information concerning the traveling speed of the requested traveling vehicle 6.

The area controller 50 periodically performs communication with a plurality of traveling vehicles 6 in its own jurisdiction area. For example, the area controller 50 transmits a status inquiry to the traveling vehicle 6 in the own jurisdiction area, and the traveling vehicle 6 that received the status inquiry transmits a status report including its own positional information and the like to the area controller 50. By periodically performing such communication with the traveling vehicles 6 in the jurisdiction area in sequence, the area controller 50 grasps the status of the traveling vehicles 6 in the jurisdiction area. The priority information is included in the above-described status report. The priority information is associated with the traveling vehicle number of the relevant traveling vehicle 6. The priority information is not particularly limited and may include other various information.

The passage-permission determination unit 52 determines, while a plurality of requested traveling vehicles 6 having routes entering the merging portion M different from one another are stored in the storage unit 51, when any of the requested traveling vehicles 6 reached the determination point D, whether to transmit the passage permission to the relevant requested traveling vehicle 6 that has reached the determination point D based on the priority information stored in the storage unit 51. The processing of the passage-permission determination unit 52 will be described later.

The area controller 50 transmits, when the passage-permission determination unit 52 has determined to transmit passage permission, the passage permission to the relevant requested traveling vehicle 6 via the passage-permission transmission unit 55. Meanwhile, the area controller 50 does not transmit the passage permission to the relevant requested traveling vehicle 6 when the passage-permission determination unit 52 has not determined to transmit the passage permission.

The request receiving unit 53 receives a request from the traveling vehicle 6. The request determination unit 54 determines whether the request received by the request receiving unit 53 is a passage permission request or a determination request. The passage-permission request table registration unit 56 registers (stores) the traveling vehicle number of the requested traveling vehicle 6 that has transmitted the passage permission request in the passage-permission request table TB1. The passage-permission request table deletion unit 57 deletes the traveling vehicle number of the requested traveling vehicle 6 that has transmitted the determination request from the passage-permission request table TB1. The passage-permission determination table registration unit 58 registers the traveling vehicle number of the requested traveling vehicle 6 that has transmitted the determination request in the passage-permission determination table TB2. The passage-permission determination table deletion unit 59 deletes the traveling vehicle number of the requested traveling vehicle 6 that has been determined to transmit the passage permission by the passage-permission determination unit 52 from the passage-permission determination table TB2. The passage-permission table registration unit 60 registers the traveling vehicle number of the requested traveling vehicle 6 that has been determined to transmit the passage permission by the passage-permission determination unit 52 in the passage permission table TB3. The passage-permission table deletion unit 61 deletes the traveling vehicle number of the requested traveling vehicle 6 that has completed passing the merging portion M from the passage permission table TB3 (cancels the passage permission).

Next, the processing of the area controller 50 will be described.

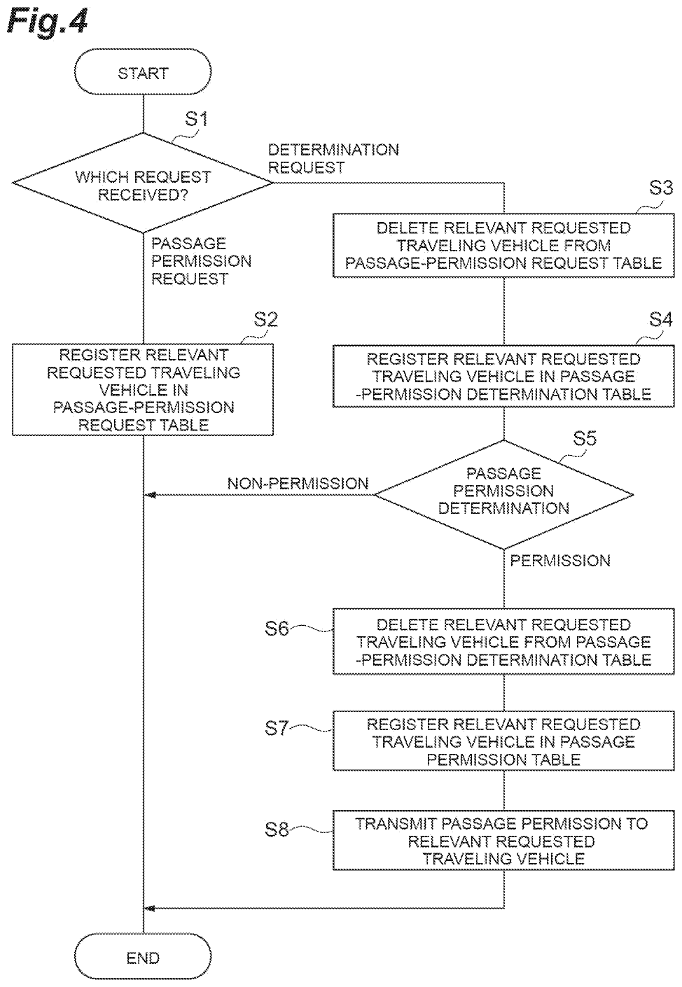

When a request from the traveling vehicle 6 was received in the request receiving unit 53, as illustrated in FIG. 4, whether the relevant request received is a passage permission request or a determination request is determined by the request determination unit 54 (Step S1). When determined that the passage permission request has been received at Step S1, the traveling vehicle number of the requested traveling vehicle 6 that has transmitted the relevant request (hereinafter also referred to as “relevant requested traveling vehicle 6”) is registered in the passage-permission request table TB1 by the passage-permission request table registration unit 56 (Step S2). After Step S2, the processing is terminated.

When determined that the determination request has been received at Step S1, the traveling vehicle number of the relevant requested traveling vehicle 6 is deleted from the passage-permission request table TB1 by the passage-permission request table deletion unit 57 (Step S3). The traveling vehicle number of the relevant requested traveling vehicle 6 is registered in the passage-permission determination table TB2 by the passage-permission determination table registration unit 58 (Step S4). Whether to transmit the passage permission to the relevant requested traveling vehicle 6 is determined by the passage-permission determination unit 52 (Step S5).

When determined not to transmit the passage permission (non-permission) at Step S5, the processing is terminated as is. When determined to transmit the passage permission (permission) at Step S5, the traveling vehicle number of the relevant requested traveling vehicle 6 is deleted from the passage-permission determination table TB2 by the passage-permission determination table deletion unit 59 (Step S6). The traveling vehicle number of the relevant requested traveling vehicle 6 is registered in the passage permission table TB3 by the passage-permission table registration unit 60 (Step S7). The passage permission is transmitted to the relevant requested traveling vehicle 6 by the passage-permission transmission unit 55 (Step S8). After Step S8, the processing is terminated.

Next, the processing of passage permission determination by the passage-permission determination unit 52 will be described.

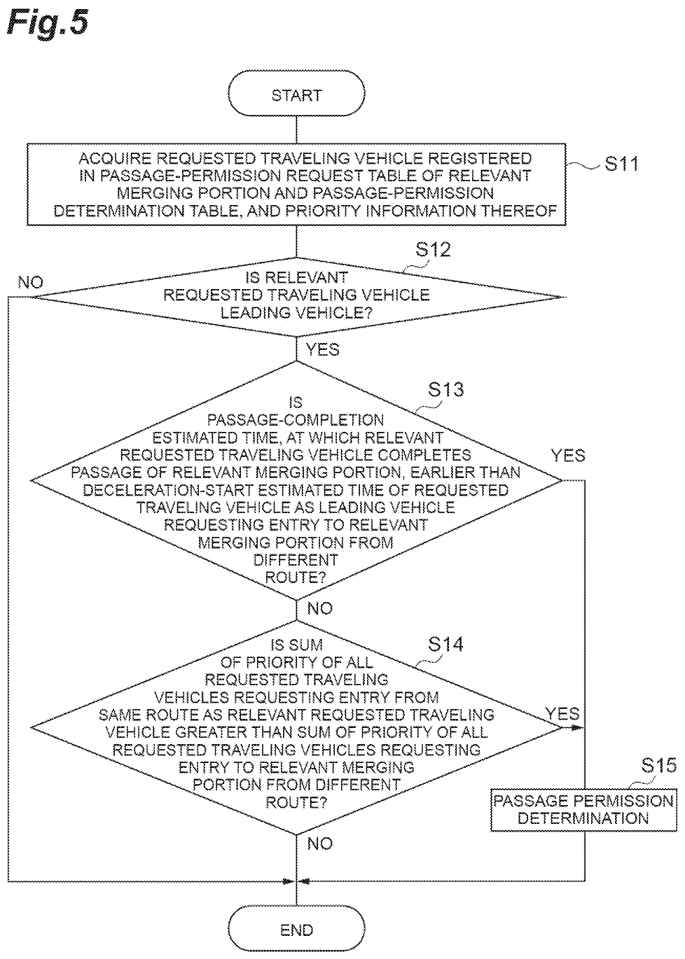

As illustrated in FIG. 5, the traveling vehicle numbers of the requested traveling vehicles 6 registered in the passage-permission request table TB1 and the passage-permission determination table TB2 of the merging portion M to be an object of passage permission (hereinafter also referred to as “relevant merging portion M”) and the priority information on the requested traveling vehicles 6 are acquired (Step S11). It is determined whether the relevant requested traveling vehicles 6 are leading vehicles (Step S12). The leading vehicle is a traveling vehicle that is traveling at the head of a traveling vehicle group composed of a plurality of requested traveling vehicles 6 for which routes entering the relevant merging portion M are the same.

If No at Step S12, it is assumed not to transmit the passage permission to the relevant requested traveling vehicle 6 and the processing is terminated. If Yes at Step S12, it is determined whether the passage-completion estimated time at which the relevant requested traveling vehicle 6 completes the passage of the relevant merging portion M is earlier than the deceleration-start estimated time of the requested traveling vehicle 6 as the leading vehicle requesting the entry to the relevant merging portion M from a different route (Step S13: intersection flow-rate securing determination).

If No at Step S13, it is determined whether the sum of the priority of all requested traveling vehicles 6 requesting the entry from the same route as that of the relevant requested traveling vehicle 6 is greater than the sum of the priority of all requested traveling vehicles 6 requesting the entry to the relevant merging portion M from a different route (Step S14: approaching-direction passage priority determination). If No at Step S14, it is assumed not to transmit the passage permission to the relevant requested traveling vehicle 6 and the processing is terminated. If Yes at Step S13 or Yes at Step S14, it is determined that the passage permission is transmitted to the relevant requested traveling vehicle 6 (passage permission determination: Step S15). The processing is terminated after Step S15.

Next, one example of specific processing executed in the traveling vehicle system 1 will be described.

The passage-permission determination unit 52 when a first requested traveling vehicle 6₁ and a second requested traveling vehicle 62 that are two requested traveling vehicles 6 having routes entering the merging portion M different from each other are present and when the first requested traveling vehicle 6₁ is the vacant traveling vehicle 6E and the second requested traveling vehicle 6₂ is the executing traveling vehicle 6T, determines whether to transmit the passage permission to the first requested traveling vehicle 6₁ that has reached the determination point D after transmitting the passage permission to the second requested traveling vehicle 6₂ that reached the determination point D.

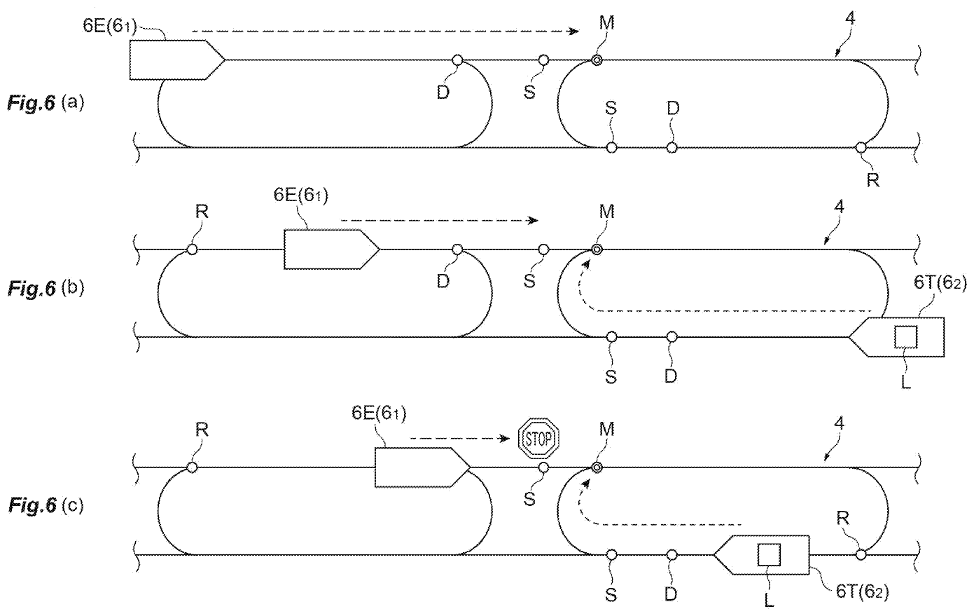

Specifically, as illustrated in FIG. 6(a), the traveling vehicle 6₁ traveling on the straight route entering the merging portion M transmits a passage permission request to the area controller 50 when reaching the request point R. As a result, the passage-permission determination unit 52 sets, in the passage-permission request table as shown in FIG. 3, the traveling vehicle number of the first requested traveling vehicle 6₁ that is the traveling vehicle 6₁ that has transmitted the passage permission request. That is, in the passage-permission request table, a list of requested traveling vehicles 6 that have transmitted the passage permission request is stored.

Subsequently, as illustrated in FIG. 6(b), the traveling vehicle 6₂ traveling on the route including a curved route entering the merging portion M transmits a passage permission request to the area controller 50 when reaching the request point R. As a result, the passage-permission determination unit 52 sets, in the passage-permission request table as shown in FIG. 3, the traveling vehicle number of the second requested traveling vehicle 6₂ that is the traveling vehicle 6₂ that has transmitted the passage permission request.

Then, as illustrated in FIG. 6(c), the first requested traveling vehicle 6₁ transmits a determination request to the area controller 50 when reaching the determination point D. As a result, the passage-permission determination unit 52 deletes the traveling vehicle number of the first requested traveling vehicle 6₁ that has transmitted the determination request from the passage-permission request table and sets it in the passage-permission determination table as shown in FIG. 3.

The passage-permission determination unit 52 reads out, when determining whether to transmit the passage permission to the traveling vehicle 6 set in the passage-permission determination table, the priority information on the requested traveling vehicle 6 set in the passage-permission determination table and on the requested traveling vehicle 6 set in the passage-permission request table, and based on the priority information on a plurality of traveling vehicles 6 read out, determines the traveling vehicle 6 to transmit the passage permission. The passage-permission determination unit 52 acquires the priority information associated with the traveling vehicle number in the passage permission determination table from the storage unit 51. The passage-permission determination unit 52 recognizes that, based on the relevant priority information, the first requested traveling vehicle 6₁ is the vacant traveling vehicle 6E. The passage-permission determination unit 52 acquires the priority information associated with the traveling vehicle number in the passage-permission request table from the storage unit 51. The passage-permission determination unit 52 recognizes that, based on the relevant priority information, the second requested traveling vehicle 6₂ is the executing traveling vehicle 6T. Because the priority of the executing traveling vehicle 6T is higher than the priority of the vacant traveling vehicle 6E, the passage-permission determination unit 52 does not determine whether to transmit the passage permission to the first requested traveling vehicle 6₁ that has reached the determination point D and leaves the traveling vehicle number of the first requested traveling vehicle 6₁ that has been set in the passage-permission determination table as is. The area controller 50 does not transmit the passage permission to the first requested traveling vehicle 6₁. As a result, the first requested traveling vehicle 6₁ decelerates in front of the stopping point S and stops at the stopping point S.

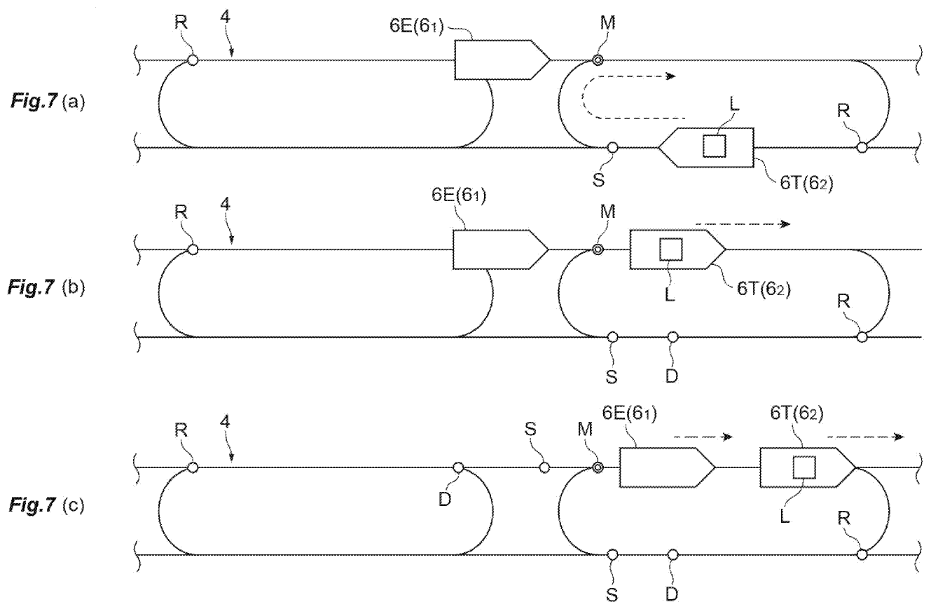

Subsequently, as illustrated in FIG. 7(a), the second requested traveling vehicle 6₂ transmits a determination request to the area controller 50 when reaching the determination point D. As a result, the passage-permission determination unit 52 deletes the traveling vehicle number of the second requested traveling vehicle 6₂ that has transmitted the determination request from the passage-permission request table and sets it in the passage-permission determination table.

The passage-permission determination unit 52 acquires the priority information associated with the traveling vehicle numbers in the passage permission determination table from the storage unit 51. The passage-permission determination unit 52 recognizes that, based on the relevant priority information, the first requested traveling vehicle 6₁ is the vacant traveling vehicle 6E and the second requested traveling vehicle 6₂ is the executing traveling vehicle 6T. Because the priority of the executing traveling vehicle 6T is higher than the priority of the vacant traveling vehicle 6E, the passage-permission determination unit 52 determines whether to transmit the passage permission to the second requested traveling vehicle 6₂ that has reached the determination point D, deletes the traveling vehicle number of the second requested traveling vehicle 6₂ from the passage-permission determination table, and sets it in the passage permission table as shown in FIG. 3. The area controller 50 transmits the passage permission to the requested traveling vehicle 6 of the traveling vehicle number in the passage permission table, that is, the second requested traveling vehicle 6₂. As a result, as illustrated in FIG. 7(b), the second requested traveling vehicle 6₂ passes through the merging portion M. After the second requested traveling vehicle 6₂ passed through the merging portion M, the passage-permission determination unit 52 deletes the traveling vehicle number of the second requested traveling vehicle 6₂ from the passage permission table.

Thereafter, the passage-permission determination unit 52 determines whether to transmit the passage permission to the first requested traveling vehicle 6₁, deletes the traveling vehicle number of the first requested traveling vehicle 6₁ from the passage-permission determination table, and sets it in the passage permission table. The area controller 50 transmits the passage permission to the first requested traveling vehicle 6₁. As a result, as illustrated in FIG. 7(c), the first requested traveling vehicle 6₁ passes through the merging portion M. After the first requested traveling vehicle 6₁ passed through the merging portion M, the passage-permission determination unit 52 deletes the traveling vehicle number of the first requested traveling vehicle 6₁ from the passage permission table.

As in the foregoing, the traveling vehicle system 1 can, by using the time it takes until the requested traveling vehicle 6 that has transmitted the passage permission request of the merging portion M at the request point R travels to the determination point D, store the priority information on another requested traveling vehicle 6 that attempts to pass through the merging portion M (traveling vehicle 6 competing concerning the passage of the merging portion M). By using this priority information, whether to transmit the passage permission to the relevant requested traveling vehicle 6 that has reached the determination point D can be determined. Thus, on a plurality of requested traveling vehicles 6, it is possible to pass through the merging portion M in an appropriate order according to the priority of the requested traveling vehicles 6 regardless of the order that the area controller 50 received the passage permission requests. That is, the traveling vehicles 6 can pass through the merging portion M in order and according to the priority.

In the traveling vehicle system 1, the priority information includes information whether the requested traveling vehicle 6 is the executing traveling vehicle 6T or the vacant traveling vehicle 6E. The passage-permission determination unit 52 when the first requested traveling vehicle 6₁ and the second requested traveling vehicle 6₂ having the routes entering the merging portion M different from each other are present and when the first requested traveling vehicle 6₁ is the vacant traveling vehicle 6E and the second requested traveling vehicle 6₂ is the executing traveling vehicle 6T, transmits the passage permission to the first requested traveling vehicle 6₁ after transmitting the passage permission to the second requested traveling vehicle 6₂ even if the first requested traveling vehicle 6₁ can pass through the merging portion M before. This makes it possible that the executing traveling vehicle 6T passes through the merging portion M before the vacant traveling vehicle 6E.

### Second Example

Next, a second example will be described. In the description of the second example, the descriptions the same as those of the first example will be omitted as appropriate.

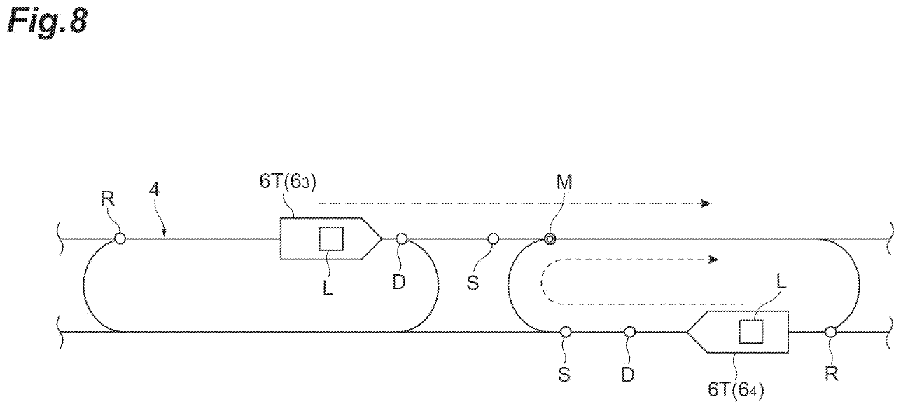

The passage-permission determination unit 52 according to the second example when as illustrated in FIG. 8, a third requested traveling vehicle 6₃ and a fourth requested traveling vehicle 6₄ having routes entering the merging portion M different from each other are present and when the third requested traveling vehicle 6₃ is the executing traveling vehicle 6T executing a first transport command and the fourth requested traveling vehicle 6₄ is the executing traveling vehicle 6T executing a second transport command having a higher order of priority than that of the first transport command, transmits the passage permission to the third requested traveling vehicle 6₃ that has reached the determination point D, after transmitting the passage permission to the fourth requested traveling vehicle 6₄ that reached the determination point D.

Specifically, the traveling vehicle 6₃ transmits a passage permission request to the area controller 50 when reaching the request point R. The passage-permission determination unit 52 sets, in the passage-permission request table, the traveling vehicle number of the third requested traveling vehicle 6₃ that is the traveling vehicle 6₃ that has transmitted the passage permission request. The traveling vehicle 6₄ transmits a passage permission request to the area controller 50 when reaching the request point R. The passage-permission determination unit 52 sets, in the passage-permission request table, the traveling vehicle number of the fourth requested traveling vehicle 6₄ that is the traveling vehicle 6₄ that has transmitted the passage permission request.

The third requested traveling vehicle 6₃ transmits a determination request to the area controller 50 when reaching the determination point D. The passage-permission determination unit 52 deletes the traveling vehicle number of the third requested traveling vehicle 6₃ that has transmitted the determination request from the passage-permission request table and sets it in the passage-permission determination table. The passage-permission determination unit 52 acquires the priority information associated with the traveling vehicle numbers in the passage-permission request table and the passage-permission determination table from the storage unit 51. The passage-permission determination unit 52, based on the relevant priority information, recognizes that the third requested traveling vehicle 6₃ and the fourth requested traveling vehicle 6₄ are the executing traveling vehicles 6T and recognizes the numerical value of priority of the first transport command executed by the third requested traveling vehicle 6₃ and the numerical value of priority of the second transport command executed by the fourth requested traveling vehicle 6₄.

The numerical value of priority of the second transport command is higher than the numerical value of priority of the second transport command, and the second transport command has a higher order of priority than that of the first transport command. Thus, the passage-permission determination unit 52 does not determine whether to transmit the passage permission to the third requested traveling vehicle 6₃ that has reached the determination point D. The area controller 50 does not transmit the passage permission to the third requested traveling vehicle 6₃.

The fourth requested traveling vehicle 6₄ transmits a determination request to the area controller 50 when reaching the determination point D. The passage-permission determination unit 52 deletes the traveling vehicle number of the fourth requested traveling vehicle 6₄ that has transmitted the determination request from the passage-permission request table and sets it in the passage-permission determination table. The passage-permission determination unit 52 acquires the priority information associated with the traveling vehicle numbers in the passage-permission request table and the passage-permission determination table from the storage unit 51. The passage-permission determination unit 52, based on the relevant priority information, recognizes that the third requested traveling vehicle 6₃ and the fourth requested traveling vehicle 6₄ are the executing traveling vehicles 6T and recognizes the numerical value of priority of the first transport command executed by the third requested traveling vehicle 6₃ and the numerical value of priority of the second transport command executed by the fourth requested traveling vehicle 6₄.

As in the foregoing, the numerical value of priority of the second transport command is higher than the numerical value of priority of the second transport command, and the second transport command has a higher order of priority than that of the first transport command. Thus, the passage-permission determination unit 52 determines whether to transmit the passage permission to the fourth requested traveling vehicle 6₄ that has reached the determination point D. The area controller 50 transmits the passage permission to the fourth requested traveling vehicle 6₄. As a result, the fourth requested traveling vehicle 6₄ passes through the merging portion M. After the fourth requested traveling vehicle 6₄ completed the passage of the merging portion M, the passage-permission determination unit 52 determines whether to transmit the passage permission to the third requested traveling vehicle 6₃ that has reached the determination point D, and the area controller 50 transmits the passage permission to the third requested traveling vehicle 6₃. As a result, the third requested traveling vehicle 6₃ passes through the merging portion M.

As in the foregoing, in the traveling vehicle system 1 of the second example also, a plurality of traveling vehicles 6 can pass through the merging portion M in order and according to the priority.

In the traveling vehicle system 1 of the second example, the third requested traveling vehicle 6₃ and the fourth requested traveling vehicle 6₄ having the routes entering the merging portion M different from each other are present. The third requested traveling vehicle 6₃ is the executing traveling vehicle 6T executing the first transport command. The fourth requested traveling vehicle 6₄ is the executing traveling vehicle 6T executing the second transport command having a higher order of priority than that of the first transport command. The passage-permission determination unit 52 determines whether to transmit the passage permission to the third requested traveling vehicle 6₃ that has reached the determination point D after transmitting the passage permission to the fourth requested traveling vehicle 6₄ that reached the determination point D, even if the third requested traveling vehicle 6₃ can pass through the merging portion M before. This makes it possible that the executing traveling vehicle 6T executing the transport command having a higher order of priority passes through the merging portion M before the executing traveling vehicle 6T executing the transport command having a lower order of priority.

### Third Example

Next, a third example will be described. In the description of the third example, the descriptions the same as those of the first example will be omitted as appropriate.

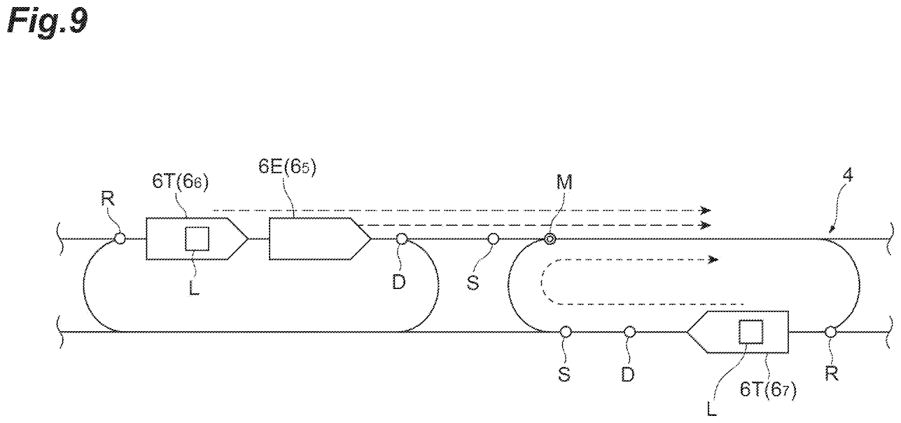

The passage-permission determination unit 52 according to the third example when, as illustrated in FIG. 9, a fifth requested traveling vehicle 6₅, a sixth requested traveling vehicle 6₆ located behind the fifth requested traveling vehicle 6₅ in the track 4 and having the same route entering the merging portion M as the fifth requested traveling vehicle 6₅, and a seventh requested traveling vehicle 6₇ having a route entering the merging portion M different from the fifth requested traveling vehicle 6₅ and the sixth requested traveling vehicle 6₆ are present, and when the fifth requested traveling vehicle 6₅ is the vacant traveling vehicle 6E and the sixth requested traveling vehicle 6₆ and the seventh requested traveling vehicle 6₇ are the executing traveling vehicles 6T, determines whether to transmit the passage permission to the seventh requested traveling vehicle 6₇ that has reached the determination point D after transmitting the passage permission to the fifth requested traveling vehicle 6₅ that reached the determination point D and transmitting the passage permission to the sixth requested traveling vehicle 6₆ that reached the determination point D.

Specifically, the passage-permission determination unit 52 sets, in the passage-permission request table, the traveling vehicle numbers of requested traveling vehicles 6 (the fifth requested traveling vehicle 6₅, the sixth requested traveling vehicle 6₆, and the seventh requested traveling vehicle 6₇) that have transmitted the passage permission requests. The passage-permission determination unit 52 deletes the traveling vehicle numbers of the requested traveling vehicles 6 that have transmitted determination requests from the passage-permission request table and sets them in the passage-permission determination table.

The passage-permission determination unit 52 acquires the priority information associated with the traveling vehicle numbers in the passage-permission request table and the passage-permission determination table from the storage unit 51. The passage-permission determination unit 52 recognizes that, based on the relevant priority information, the fifth requested traveling vehicle 6₅ is the vacant traveling vehicle 6E and the sixth requested traveling vehicle 6₆ and the seventh requested traveling vehicle 6₇ are the executing traveling vehicles 6T. The passage-permission determination unit 52 recognizes that, based on the relevant priority information, the routes that the fifth requested traveling vehicle 6₅ and the sixth requested traveling vehicle 6₆ travel are the same.

When there are a plurality of requested traveling vehicles 6 on each route entering the merging portion M, it is more efficient when the requested traveling vehicle 6 of a different route passes through the merging portion M after the requested traveling vehicles 6 having the same entering route successively passed through the merging portion M, rather than the traveling vehicles 6 of different routes alternately passing through the merging portion M. That is, the requested traveling vehicles 6 as a whole can pass through the merging portion M in a short time. The passage-permission determination unit 52 prioritizes the route with a large number of traveling vehicles 6 while prioritizing the executing traveling vehicle 6T and determines whether to transmit the passage permission to the fifth requested traveling vehicle 6₅, the sixth requested traveling vehicle 6₆, and the seventh requested traveling vehicle 6₇. That is, the passage-permission determination unit 52 determines whether to transmit the passage permission to the seventh requested traveling vehicle 6₇, after determining to transmit the passage permission to the fifth requested traveling vehicle 6₅ and determining to transmit the passage permission to the sixth requested traveling vehicle 6₆. Consequently, the area controller 50 transmits the passage permission to the fifth requested traveling vehicle 65, transmits the passage permission to the sixth requested traveling vehicle 6₆, and after the fifth requested traveling vehicle 6₅ and the sixth requested traveling vehicle 6₆ completed the passage of the merging portion M, transmits the passage permission to the seventh requested traveling vehicle 6₇. As a result, after the fifth requested traveling vehicle 6₅ and the sixth requested traveling vehicle 6₆ successively passed through the merging portion M, the seventh requested traveling vehicle 6₇ passes through the merging portion M.

As in the foregoing, in the traveling vehicle system 1 of the third example also, a plurality of traveling vehicles 6 can pass through the merging portion M in order and according to the priority.

In the traveling vehicle system 1 of the third example, the fifth requested traveling vehicle 6₅, the sixth requested traveling vehicle 6₆ located behind the fifth requested traveling vehicle 6₅ and having the same route entering the merging portion M as the fifth requested traveling vehicle 6₅, and the seventh requested traveling vehicle 6₇ having the routes entering the merging portion M different from the fifth requested traveling vehicle 6₅ and the sixth requested traveling vehicle 6₆ are present. The fifth requested traveling vehicle 6₅ is the vacant traveling vehicle 6E, the sixth requested traveling vehicle 6₆ is the executing traveling vehicle 6T, and the seventh requested traveling vehicle 6₇ is the executing traveling vehicle 6T. The passage-permission determination unit 52 transmits the passage permission to the fifth requested traveling vehicle 6₅ that has reached the determination point D, and after transmitting the passage permission to the sixth requested traveling vehicle 6₆ that reached the determination point D, determines whether to transmit the passage permission to the seventh requested traveling vehicle 6₇ that has reached the determination point D. As a result, the sixth requested traveling vehicle 6₆ that is the executing traveling vehicle 6T preferentially passes through the merging portion M. In addition, the fifth requested traveling vehicle 6₅ that is the vacant traveling vehicle 6E that has to pass through the merging portion M inevitably in order for the sixth requested traveling vehicle 6₆ to pass through the merging portion M precedes to pass through the merging portion M without waiting for the passage. Thus, the system as a whole can achieve efficient traveling of the traveling vehicles 6.

### Fourth Example

Next, a fourth example will be described. In the description of the fourth example, the descriptions the same as those of the first example will be omitted as appropriate.

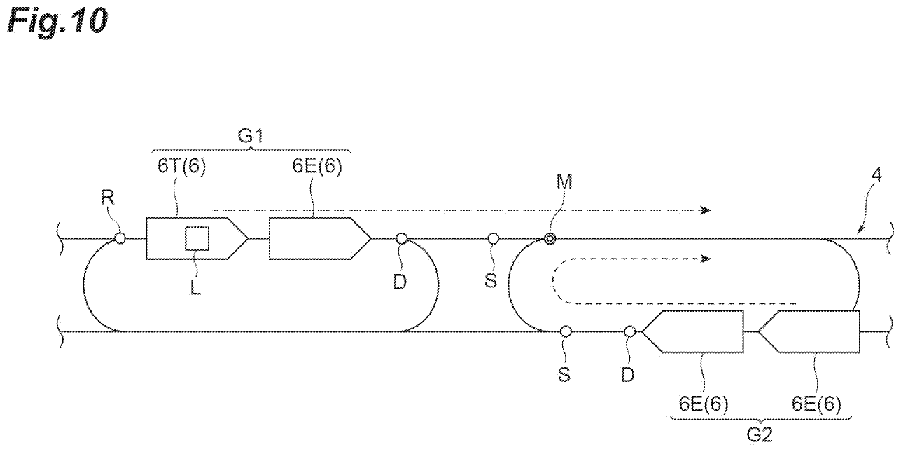

The passage-permission determination unit 52 according to the fourth example when, as illustrated in FIG. 10, a first traveling vehicle group G1 and a second traveling vehicle group G2 are present and when at least one of the requested traveling vehicles 6 in the first traveling vehicle group G1 is the executing traveling vehicle 6T and all requested traveling vehicles 6 in the second traveling vehicle group G2 are the vacant traveling vehicles 6E, determines whether to transmit the passage permission to the requested traveling vehicle 6 of the second traveling vehicle group G2 after transmitting the passage permission to all of the requested traveling vehicles 6 in the first traveling vehicle group G1. The first traveling vehicle group G1 is composed of a plurality of requested traveling vehicles 6 for which routes entering the merging portion M are the same. The second traveling vehicle group G2 is composed of a plurality of requested traveling vehicles 6 for which routes entering the merging portion M are the same and the routes entering the merging portion M are different from those of the first traveling vehicle group G1.

Specifically, the passage-permission determination unit 52 sets, in the passage-permission request table, the traveling vehicle numbers of the requested traveling vehicles 6 (the requested traveling vehicles 6 of the first traveling vehicle group G1 and the second traveling vehicle group G2) that have transmitted a passage permission request. The passage-permission determination unit 52 deletes the traveling vehicle numbers of the requested traveling vehicles 6 that have transmitted determination requests from the passage-permission request table and sets them in the passage-permission determination table.

The passage-permission determination unit 52 acquires the priority information associated with the traveling vehicle numbers in the passage-permission request table and the passage-permission determination table from the storage unit 51. The passage-permission determination unit 52 recognizes that, based on the relevant priority information, at least any (one, in this example) of the requested traveling vehicles 6 in the first traveling vehicle group G1 is the executing traveling vehicle 6T and the requested traveling vehicles 6 other than that are the vacant traveling vehicles 6E.

The passage-permission determination unit 52 determines whether to transmit the passage permission by prioritizing the first traveling vehicle group G1 including the executing traveling vehicle 6T over the second traveling vehicle group G2 of all vacant traveling vehicles 6E. That is, the passage-permission determination unit 52 determines whether to transmit the passage permission to the requested traveling vehicles 6 of the second traveling vehicle group G2, after transmitting the passage permission to all requested traveling vehicles 6 of the first traveling vehicle group G1. Consequently, the area controller 50 transmits the passage permission to all requested traveling vehicles 6 of the first traveling vehicle group G1, and transmits the passage permission to the requested traveling vehicles 6 of the second traveling vehicle group G2 after all requested traveling vehicles 6 of the first traveling vehicle group G1 completed the passage of the merging portion M. As a result, after the requested traveling vehicles 6 of the first traveling vehicle group G1 successively passed through the merging portion M, the requested traveling vehicles 6 of the second traveling vehicle group G2 successively pass through the merging portion M.

As in the foregoing, in the traveling vehicle system 1 of the fourth example also, a plurality of traveling vehicles 6 can pass through the merging portion M in order and according to the priority.

In the traveling vehicle system 1 of the fourth example, the first traveling vehicle group G1 composed of a plurality of requested traveling vehicles 6 for which the routes entering the merging portion M are the same and the second traveling vehicle group G2 composed of a plurality of requested traveling vehicles 6 for which the routes entering the merging portion M are the same and are different from that of the first traveling vehicle group G1 are present. At least any of the requested traveling vehicles 6 in the first traveling vehicle group G1 is the executing traveling vehicle 6T. All requested traveling vehicles 6 in the second traveling vehicle group G2 are the vacant traveling vehicles 6E. The passage-permission determination unit 52 determines whether to transmit the passage permission to the requested traveling vehicle 6 of the second traveling vehicle group G2 after transmitting the passage permission to all requested traveling vehicles 6 of the first traveling vehicle group G1, even if the traveling vehicle 6 of the second traveling vehicle group G2 can pass through the merging portion M before. As a result, the executing traveling vehicle 6T can pass through the merging portion M before the vacant traveling vehicle 6E, and a plurality of traveling vehicles 6 attempting to enter the merging portion M on the same route can pass through the merging portion M successively.

### Fifth Example

Next, a fifth example will be described. In the description of the fifth example, the descriptions the same as those of the first example will be omitted as appropriate.

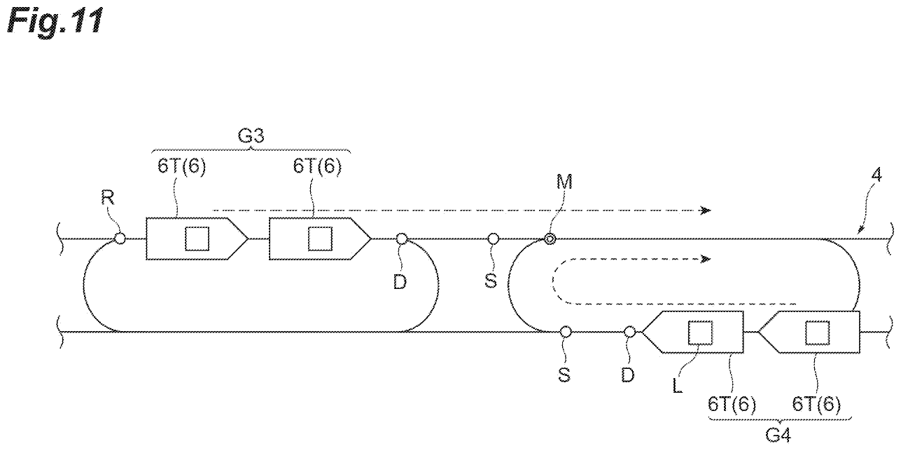

The passage-permission determination unit 52 according to the fifth example when, as illustrated in FIG. 11, a third traveling vehicle group G3 and a fourth traveling vehicle group G4 are present and when at least one of the requested traveling vehicles 6 in the third traveling vehicle group G3 is the executing traveling vehicle 6T, at least one of the requested traveling vehicles 6 in the fourth traveling vehicle group G4 is the executing traveling vehicle 6T, and the sum of the priority of transport command being executed by the executing traveling vehicles 6T included in the third traveling vehicle group G3 is greater than the sum of the priority of transport command being executed by the executing traveling vehicles 6T included in the fourth traveling vehicle group G4, determines whether to transmit the passage permission to the requested traveling vehicles 6 of the fourth traveling vehicle group G4 after transmitting the passage permission to all requested traveling vehicles 6 in the third traveling vehicle group G3. The third traveling vehicle group G3 is composed of a plurality of requested traveling vehicles 6 for which routes entering the merging portion M are the same. The fourth traveling vehicle group G4 is composed of a plurality of requested traveling vehicles 6 for which routes entering the merging portion M are the same and the routes entering the merging portion M are different from the third traveling vehicle group G3.

Specifically, the passage-permission determination unit 52 sets, in the passage-permission request table, the traveling vehicle numbers of the requested traveling vehicles 6 (the requested traveling vehicles 6 of the third traveling vehicle group G3 and the fourth traveling vehicle group G4) that have transmitted passage permission requests. The passage-permission determination unit 52 deletes the traveling vehicle numbers of the requested traveling vehicles 6 that have transmitted determination requests from the passage-permission request table and sets them in the passage-permission determination table.

The passage-permission determination unit 52 acquires the priority information associated with the traveling vehicle numbers in the passage-permission request table and the passage-permission determination table from the storage unit 51. The passage-permission determination unit 52, based on the relevant priority information, recognizes that all requested traveling vehicles 6 in the third traveling vehicle group G3 and the fourth traveling vehicle group G4 are the executing traveling vehicles 6T and recognizes the numerical value of the priority of each transport command executed by the relevant executing traveling vehicles 6T.

The passage-permission determination unit 52 sums the numerical value of the priority of each executing traveling vehicle 6T in the third traveling vehicle group G3 and calculates the sum. The passage-permission determination unit 52 sums the numerical value of the priority of each executing traveling vehicle 6T in the fourth traveling vehicle group G4 and calculates the sum. The passage-permission determination unit 52, when the sum of the priority of the third traveling vehicle group G3 is greater than the sum of the priority of the fourth traveling vehicle group G4, determines whether to transmit the passage permission to the requested traveling vehicles 6 of the fourth traveling vehicle group G4, after transmitting the passage permission to all requested traveling vehicles 6 of the third traveling vehicle group G3. Consequently, the area controller 50 transmits the passage permission to all requested traveling vehicles 6 of the third traveling vehicle group G3, and after all requested traveling vehicles 6 of the third traveling vehicle group G3 completed the passage of the merging portion M, transmits the passage permission to the requested traveling vehicles 6 of the fourth traveling vehicle group G4. As a result, after the requested traveling vehicles 6 of the third traveling vehicle group G3 successively passed through the merging portion M, the requested traveling vehicles 6 of the fourth traveling vehicle group G4 successively pass through the merging portion M.

As in the foregoing, in the traveling vehicle system 1 of the fifth example also, a plurality of traveling vehicles 6 can pass through the merging portion M in order and according to the priority.

In the traveling vehicle system 1 of the fifth example, the third traveling vehicle group G3 composed of a plurality of requested traveling vehicles 6 for which the routes entering the merging portion M are the same and the fourth traveling vehicle group G4 composed of a plurality of requested traveling vehicles 6 for which the routes entering the merging portion M are the same and are different from the third traveling vehicle group G3 are present. At least any of the requested traveling vehicles 6 in the third traveling vehicle group G3 is the executing traveling vehicle 6T and at least one of the requested traveling vehicles 6 in the fourth traveling vehicle group G4 is the executing traveling vehicle 6T. The sum of the priority of transport command being executed by the executing traveling vehicles 6T included in the third traveling vehicle group G3 is greater than the sum of the priority of transport command being executed by the executing traveling vehicles 6T included in the fourth traveling vehicle group G4. In this example, the passage-permission determination unit 52 determines whether to transmit the passage permission to the requested traveling vehicles 6 of the fourth traveling vehicle group G4, after transmitting the passage permission to all requested traveling vehicles 6 of the third traveling vehicle group G3, even if the requested traveling vehicles 6 of the fourth traveling vehicle group G4 can pass through the merging portion M before. As a result, the executing traveling vehicle 6T that is executing a transport command having a higher order of priority is made easy to pass through the merging portion M before the executing traveling vehicle 6T that is executing a transport command having a lower order of priority, and a plurality of traveling vehicles 6 attempting to enter the merging portion M on the same route can pass through the merging portion M successively.

The priority information may include information concerning not the priority that is greater as the order of priority of transport command is higher but the priority that is smaller as the order of priority of transport command is higher. In this example, the passage-permission determination unit 52 determines whether to transmit the passage permission to the requested traveling vehicle 6 of the fourth traveling vehicle group G4, after transmitting the passage permission to all requested traveling vehicles 6 of the third traveling vehicle group G3, when the sum of the priority of transport command being executed by the executing traveling vehicles 6T included in the third traveling vehicle group G3 is smaller than the sum of the priority of transport command being executed by the executing traveling vehicles 6T included in the fourth traveling vehicle group G4.

### Sixth Example

Next, a sixth example will be described. In the description of the sixth example, the descriptions the same as those of the first example will be omitted as appropriate.

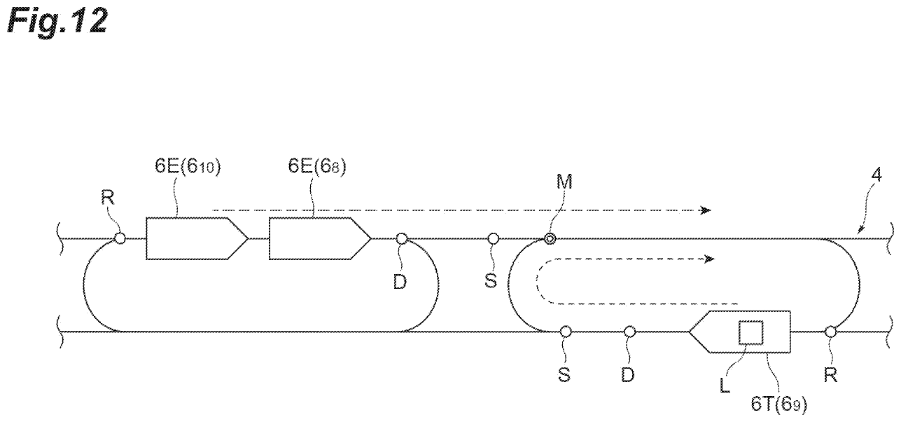

The passage-permission determination unit 52 according to the sixth example, as illustrated in FIG. 12, when an eighth requested traveling vehicle 6₈, a ninth requested traveling vehicle 6₉, and a tenth requested traveling vehicle 6₁₀ are present, determines whether the eighth requested traveling vehicle 6₈, the ninth requested traveling vehicle 6₉, and the tenth requested traveling vehicle 6₁₀ can pass through the merging portion M in the foregoing order, based on the time it takes until they reach the merging portion M. The eighth requested traveling vehicle 6₈ and the ninth requested traveling vehicle 6₉ have routes entering the merging portion M different from each other. The tenth requested traveling vehicle 6₁₀ has the same route entering the merging portion M as the eighth requested traveling vehicle 6₈. The tenth requested traveling vehicle 6₁₀ is located behind the eighth requested traveling vehicle 6₈ in the track 4. The eighth requested traveling vehicle 6₈ and the tenth requested traveling vehicle 6₁₀ are the vacant traveling vehicles 6E. The ninth requested traveling vehicle 6₉ is the executing traveling vehicle 6T.

The passage-permission determination unit 52, when determined that it is possible for the eighth requested traveling vehicle 6₈ to complete the passage of the merging portion M before the ninth requested traveling vehicle 6₉ reaches the merging portion M and determined that it is not possible for the tenth requested traveling vehicle 6₁₀ to complete the passage of the merging portion M before the ninth requested traveling vehicle 6₉ reaches the merging portion M (it is possible for the ninth requested traveling vehicle 6₉ to complete the passage of the merging portion M before the tenth requested traveling vehicle 6₁₀ reaches the merging portion M), determines whether to communicate the passage permission to the tenth requested traveling vehicle 6₁₀ that has reached the determination point D, after communicating the passage permission to the eighth requested traveling vehicle 6₈ that reached the determination point D and communicating the passage permission to the ninth requested traveling vehicle 6₉ that reached the determination point D.

Specifically, the passage-permission determination unit 52 sets, in the passage-permission request table, the traveling vehicle numbers of the requested traveling vehicles 6 (the eighth requested traveling vehicle 6₈, the ninth requested traveling vehicle 6₉, and the tenth requested traveling vehicle 6₁₀) that have transmitted passage permission requests. The passage-permission determination unit 52 deletes the traveling vehicle numbers of the requested traveling vehicles 6 that have transmitted determination requests from the passage-permission request table and sets them in the passage-permission determination table.

The passage-permission determination unit 52 acquires the priority information associated with the traveling vehicle numbers in the passage-permission request table and the passage-permission determination table from the storage unit 51. The passage-permission determination unit 52 calculates, based on the relevant priority information, the estimated arrival time at which the eighth requested traveling vehicle 6₈, the ninth requested traveling vehicle 6₉, and the tenth requested traveling vehicle 6₁₀ reach the merging portion M. The passage-permission determination unit 52, when determined that the merging-portion passage completion estimated time (estimated time to complete the passage of the merging portion M) of the eighth requested traveling vehicle 6₈ calculated from the arrival estimated time of the eighth requested traveling vehicle 6₈ is earlier than the deceleration-start estimated time (estimated time to start decelerating in order to stop at the stopping point S) of the ninth requested traveling vehicle 6₉ calculated from the arrival estimated time of the ninth requested traveling vehicle 6₉, determines that it is possible for the eighth requested traveling vehicle 6₈ and the ninth requested traveling vehicle 6₉ to pass through the merging portion M in the foregoing order. The passage-permission determination unit 52, when determined that the merging-portion passage completion estimated time of the ninth requested traveling vehicle 6₉ calculated from the arrival estimated time of the ninth requested traveling vehicle 6₉ is earlier than the deceleration-start estimated time of the tenth requested traveling vehicle 6₁₀ calculated from the arrival estimated time of the tenth requested traveling vehicle 6₁₀, determines that it is not possible for the tenth requested traveling vehicle 6₁₀ to complete the passage of the merging portion M before the ninth requested traveling vehicle 6₉ reaches the merging portion M. The arrival estimated time, the deceleration-start estimated time, and the passage-completion estimated time may be calculated by the controllers of the eighth requested traveling vehicle 6₈, the ninth requested traveling vehicle 6₉, and the tenth requested traveling vehicle 6₁₀. That is, the passage-permission determination unit 52 may make the above-described determination based on the arrival estimated time, the deceleration-start estimated time, and the passage-completion estimated time received from the eighth requested traveling vehicle 6₈, the ninth requested traveling vehicle 6₉, and the tenth requested traveling vehicle 6₁₀.

The passage-permission determination unit 52, when determined that the eighth requested traveling vehicle 6₈, the ninth requested traveling vehicle 6₉, and the tenth requested traveling vehicle 6₁₀ can pass through the merging portion M in the foregoing order, determines to communicate the passage permission in order of the eighth requested traveling vehicle 6₈, the ninth requested traveling vehicle 6₉, and the tenth requested traveling vehicle 6₁₀. Consequently, the area controller 50 transmits the passage permission to the eighth requested traveling vehicle 6₈, and after the eighth requested traveling vehicle 6₈ completed the passage of the merging portion M, determines whether to transmit the passage permission to the ninth requested traveling vehicle 6₉. In this example, because the eighth requested traveling vehicle 6₈ has completed the passage of the merging portion M before the ninth requested traveling vehicle 6₉ starts decelerating in order to stop at the stopping point S, the eighth requested traveling vehicle 6₈ does not affect the time needed for the ninth requested traveling vehicle 6₉ to pass through the merging portion M. The passage permission is transmitted to the ninth requested traveling vehicle 6₉, and after the ninth requested traveling vehicle 6₉ completed the passage of the merging portion M, whether to transmit the passage permission to the tenth requested traveling vehicle 6₁₀ is determined. As a result, after the eighth requested traveling vehicle 6₈ passed through the merging portion M and the ninth requested traveling vehicle 6₉ passed through the merging portion M, the tenth requested traveling vehicle 6₁₀ passes through the merging portion M.

As in the foregoing, in the traveling vehicle system 1 of the sixth example also, a plurality of traveling vehicles 6 can pass through the merging portion M in order and according to the priority.

In the traveling vehicle system 1 of the sixth example, when determined that the merging-portion passage completion estimated time of the eighth requested traveling vehicle 6₈ is earlier than the deceleration-start estimated time of the ninth requested traveling vehicle 6₉, whether to transmit the passage permission to the ninth requested traveling vehicle 6₉ is determined, after transmitting the passage permission to the eighth requested traveling vehicle 6₈. As a result, on the eighth requested traveling vehicle 6₈ that can pass through the merging portion M before the ninth requested traveling vehicle 6₉, it can be made to pass through the merging portion M more preferentially than the ninth requested traveling vehicle 6₉. Furthermore, when determined that the merging-portion passage completion estimated time of the ninth requested traveling vehicle 6₉ is earlier than the deceleration-start estimated time of the tenth requested traveling vehicle 6₁₀, whether to transmit the passage permission to the tenth requested traveling vehicle 6₁₀ is determined, after transmitting the passage permission to the ninth requested traveling vehicle 6₉. As a result, on the ninth requested traveling vehicle 6₉ that can pass through the merging portion M before the tenth requested traveling vehicle 6₁₀, it can be made to pass through the merging portion M more preferentially than the tenth requested traveling vehicle 6₁₀.

As in the foregoing, my systems are not limited to the above-described examples, and various modifications are possible.

In the traveling vehicle system 1 of the above-described examples, although the area controller 50 includes the storage unit 51 and the passage-permission determination unit 52, other controllers may include the storage unit 51 and the passage-permission determination unit 52. In the traveling vehicle system 1 of the above-described examples, the positional relation among the merging portion M, the stopping point S, the determination point D, and the request point R is not particularly limited. The merging portion M, the stopping point S, the determination point D, and the request point R can be set, as appropriate, depending on the layout and the like of the track 4.

The scenes in which the traveling vehicle system according to an example is applicable are not limited to the scenes of the above-described examples. The traveling vehicle system according to one example is applicable to various scenes as long as it is the scene in which a plurality of traveling vehicles 6 having routes entering the merging portion M different from one another are present. For example, the traveling vehicle system according to one example may be a configuration in which all of the first to the fifth examples are included, or may be a configuration in which at least one of the first to the fifth examples are included. The merging portion M that the traveling vehicle system according to one example targets is not limited to those of the above-described examples, and any merging portions can be targeted.

1.-7. (canceled)

8. A traveling vehicle system comprising:
a track having a merging portion in a selected location;
a plurality of traveling vehicles configured to travel along the track; and
a controller configured to control the traveling vehicles, wherein
each of the traveling vehicles transmits a passage permission request to the controller when reaching a request point upstream of the merging portion in the track, passes through the merging portion when receiving passage permission of the merging portion, and stops at a stopping point downstream of the request point in the track and upstream of the merging portion when not receiving the passage permission, and
the controller includes:
a storage unit configured to store therein requested traveling vehicles that are one or a plurality of traveling vehicles that have transmitted the passage permission requests and priority information concerning priority of each requested traveling vehicle, each of the requested traveling vehicles transmits a determination request to the controller when reaching a determination point upstream of the stopping point in the track; and
a passage-permission determination unit configured to, when any of the requested traveling vehicles receive the determination request while the requested traveling vehicles having routes entering the merging portion different from one another are stored in the storage unit, determine whether to transmit the passage permission to the relevant requested traveling vehicle that has transmitted the determination request, based on the priority information stored in the storage unit.

9. The traveling vehicle system according to claim 8, wherein
the priority information includes information on whether the requested traveling vehicle is an executing traveling vehicle executing a transport command on an article or a vacant traveling vehicle, and
the passage-permission determination unit, when a first requested traveling vehicle and a second requested traveling vehicle having routes entering the merging portion different from each other are present and when the first requested traveling vehicle is the vacant traveling vehicle and the second requested traveling vehicle is the executing traveling vehicle, determines whether to transmit the passage permission to the first requested traveling vehicle that has transmitted the determination request, after transmitting the passage permission to the second requested traveling vehicle that transmitted the determination request.

10. The traveling vehicle system according to claim 8, wherein
the priority information includes information on whether the requested traveling vehicle is an executing traveling vehicle executing a transport command on an article or a vacant traveling vehicle; and information concerning order of priority of the transport command, and
the passage-permission determination unit, when a third requested traveling vehicle and a fourth requested traveling vehicle having routes entering the merging portion different from each other are present and when the third requested traveling vehicle is the executing traveling vehicle executing a first transport command and the fourth requested traveling vehicle is the executing traveling vehicle executing a second transport command having a higher order of priority than the first transport command, determines whether to transmit the passage permission to the third requested traveling vehicle that has transmitted the determination request, after transmitting the passage permission to the fourth requested traveling vehicle that transmitted the determination request.

11. The traveling vehicle system according to claim 8, wherein
the priority information includes information on whether the requested traveling vehicle is an executing traveling vehicle executing a transport command on an article or a vacant traveling vehicle, and
the passage-permission determination unit, when a fifth requested traveling vehicle, a sixth requested traveling vehicle located behind the fifth requested traveling vehicle in the track and having a same route entering the merging portion as the fifth requested traveling vehicle, and a seventh requested traveling vehicle having a route entering the merging portion different from the fifth requested traveling vehicle and the sixth requested traveling vehicle are present and when the fifth requested traveling vehicle is the vacant traveling vehicle, the sixth requested traveling vehicle is the executing traveling vehicle, and the seventh requested traveling vehicle is the executing traveling vehicle, determines whether to transmit the passage permission to the seventh requested traveling vehicle that has transmitted the determination request, after transmitting the passage permission to the fifth requested traveling vehicle that transmitted the determination request and transmitting the passage permission to the sixth requested traveling vehicle that transmitted the determination request.

12. The traveling vehicle system according to claim 8, wherein
the priority information includes information on whether the requested traveling vehicle is an executing traveling vehicle executing a transport command on an article or a vacant traveling vehicle, and
the passage-permission determination unit, when a first traveling vehicle group composed of the requested traveling vehicles having a same route entering the merging portion and a second traveling vehicle group composed of the requested traveling vehicles having a same route entering the merging portion and being different from the first traveling vehicle group are present, and when at least one of the requested traveling vehicles in the first traveling vehicle group is the executing traveling vehicle and all requested traveling vehicles in the second traveling vehicle group are the vacant traveling vehicles, determines whether to transmit the passage permission to the requested traveling vehicle of the second traveling vehicle group, after transmitting the passage permission to all requested traveling vehicles in the first traveling vehicle group.

13. The traveling vehicle system according to claim 8, wherein
the priority information includes: information on whether the requested traveling vehicle is an executing traveling vehicle executing a transport command on an article or a vacant traveling vehicle; and information concerning priority that is greater as an order of priority of the transport command is higher, and
the passage-permission determination unit, when a third traveling vehicle group composed of the requested traveling vehicles having a same route entering the merging portion and a fourth traveling vehicle group composed of the requested traveling vehicles having a same route entering the merging portion and being different from the third traveling vehicle group are present, and when at least one of the requested traveling vehicles in the third traveling vehicle group is the executing traveling vehicle, at least one of the requested traveling vehicles in the fourth traveling vehicle group is the executing traveling vehicle, and a sum of priority of the transport command being executed by the executing traveling vehicle included in the third traveling vehicle group is greater than a sum of priority of the transport command being executed by the executing traveling vehicle included in the fourth traveling vehicle group, determines whether to transmit the passage permission to the requested traveling vehicle of the fourth traveling vehicle group, after transmitting the passage permission to all requested traveling vehicles in the third traveling vehicle group.

14. The traveling vehicle system according to claim 8, wherein the passage-permission determination unit, when an eighth requested driving vehicle and a ninth requested traveling vehicle having routes entering the merging portion different from each other are present, determines whether the eighth requested traveling vehicle is able to complete passage of the merging portion before the ninth requested traveling vehicle starts decelerating to stop at the stopping point, and when determined possible to pass through the merging portion as a result of the relevant determination, determines whether to transmit the passage permission to the ninth requested traveling vehicle that has transmitted the determination request, after transmitting the passage permission to the eighth requested traveling vehicle that transmitted the determination request.
